(19) United States
(12) Patent Application Publication
(10) Pub. No.: US 2005/0056686 A1
(43) Pub. Date: Mar. 17, 2005

(54) Hydrogen gas brazing method for manufacturing a diamond tool and arch-shaped hydrogen gas brazing apparatus for performing the same

(75) Inventors: Jong-Hoon Kim, Yongin-si (KR); Dae-Jin Kim, Nam-gu (KR)

Correspondence Address: Peter F. Corless;EDWARDS & ANGELL, LLP, P.O. Box 55874, Boston, MA, 02205, US

(73) Assignee: Accutech Co., Ltd and Korea Institute of Industrial Technology

(21) Appl. No.: 10/835,357

(22) Filed: Apr. 28, 2004

(30) Foreign Application Priority Data
Sep. 15, 2003 (KR) 2003-63736
Sep. 15, 2003 (KR) 2003-63737

(51) Int. Cl. B23K 31/02

(52) U.S. Cl. 228/234.1

(57) ABSTRACT

To prevent oxidation and carbonization of a diamond, a heating unit includes an outside wall, a second furnace core tube coupled from an inlet to an outlet, and a heating device for heating a brazing object moved from the inlet into the outlet. A supplying unit includes a first furnace core tube to move the brazing object into the inlet, wherein the first furnace core tube is extended from the inlet. A cooling unit includes a third furnace core tube and a cooling device for cooling the brazing object moved from the outlet through the third furnace core tube, wherein the third furnace core tube is extended from the outlet. A moving unit moves the brazing object using a conveyer set to the inside of the first, second, and third furnace core tubes. A hydrogen gas supplying unit supplies hydrogen gas to the first, second, and third furnace core tubes.

### CROSS-REFERENCE TO RELATED APPLICATIONS

This application claims priority from Korean Patent Application Nos. 2003-63736, filed on Sep. 15, 2003 and 2003-63737, filed on Sep. 15, 2003, the contents of which are incorporated herein by reference in their entirety.

### BACKGROUND OF THE INVENTION

1. Field of the Invention

The present invention relates to a hydrogen gas brazing method for manufacturing a diamond tool and a hydrogen gas brazing apparatus for performing the same. More particularly, the present invention relates to a hydrogen gas brazing method for manufacturing a diamond tool in an arch-shaped hydrogen gas brazing apparatus, and an arch-shaped hydrogen gas brazing apparatus for performing the same.

2. Description of the Related Art

A diamond tool is employed in the fields of engineering, construction, and stone industry. Particularly, the diamond tool is manufactured as various tools for drilling, sawing, grinding, etc.

FIG. 1 is a perspective view illustrating a conventional diamond tool. Here, a diamond sinter (2) is manufactured using diamond abrasive grain powder (1) by powder metallurgical route, and then is adhered to a metal bulk (3).

The diamond tool should adjust the property of matrix to fix diamond particles and the initial embedding quantity of the diamond particles in accordance with the conditions of workpiece, instrument, and work. Also, the manufacturing process of the diamond tool needs long time. In addition, as the diamond sinter is worn away during the process, the diamond particles are broken off or left at processing sections to cause excessive abrasion, which is a disadvantage to lower the processing efficiency of the diamond tool.

FIG. 2 is a perspective view illustrating the diamond tool with the diamond particles fixed to the metal bulk by the brazing method after adhered directly to the metal bulk.

The brazing method is a method to fix the diamond particles 11 to the metal bulk 13 by melting and cooling a filler. As the filler for the brazing method, a nickel-based filler having greatly high bonding strength is used. However, the melting temperature of the nickel-based filler is about 1050 to 1150° C., and so a problem exists in that the diamond may be oxidized and carbonized under this temperature range.

Natural diamond is a stable material that is not oxidized and carbonized at high temperature. Whereas, artificial diamond used to manufacture the diamond tool is oxidized when the temperature is above 500° C. Additionally, artificial diamond is carbonized as the temperature is increased due to nickel and others included therein. As a result, the artificial diamond may not have sufficient strength.

Therefore, this method performs the brazing in vacuum so as to prevent oxidation of the diamond. However, when the nickel-based filler having high bonding strength is used in the brazing method, the diamond's oxidation and carbonization may not be prevented from occurring because the nickel-based filler has high melting temperature. Size of the diamond particle is reduced by oxidation, and so unoxidized part of the diamond particle functions as the diamond tool. Whereas, the diamond particle is changed into graphite by carbonization, and thus the carbonized diamond particle may not function as the diamond tool.

### SUMMARY OF THE INVENTION

It is a purpose of the present invention is to provide a hydrogen gas brazing method for manufacturing a diamond tool and an arch-shaped hydrogen gas brazing apparatus for performing the same capable of preventing oxidation and carbonization of diamond particle.

One embodiment of the present invention is to provide an arch-shaped hydrogen gas brazing apparatus which includes a heating unit, a supplying unit, a cooling unit, a moving unit, and a hydrogen gas supplying unit, wherein the brazing object is a metal bulk to which a plurality of diamond particles directly adhered. The heating unit includes an outside wall, a second furnace core tube coupled horizontally from an inlet to an outlet, and a heating device for heating the brazing object moving from the inlet into the outlet, wherein the inlet and the outlet are formed at both sides of the outside wall, and an adiabatic member is set to insides of the outside wall. The supplying unit includes a first furnace core tube to move the brazing object into the inlet, wherein the first furnace core tube is coupled to the inlet and is extended with downward tilt from the inlet. The cooling unit includes a third furnace core tube and a cooling device for cooling the brazing object moving from the outlet through the third furnace core tube, wherein the third furnace core tube is coupled to the outlet and is extended with downward tilt from the outlet. The moving unit moves the brazing object using a conveyer set to the inside of the first, second, and third furnace core tubes. The hydrogen gas supplying unit supplies hydrogen gas to the first, second, and third furnace core tubes. The heating device is desirable to be a nonmetallic heating element set to the top and bottom of the second furnace core tube. The heating unit is desirable to have a plurality of temperature sensors on the top of the second furnace core tube. The cooling device is desirable to have a plurality of water-cooled jackets surrounding the third furnace core tube. The moving unit is desirable to have a conveyer comprised a mesh belt. The hydrogen gas supplying unit is desirable to have a hydrogen gas refinery for supplying refined hydrogen gas to the first, second, and third furnace core tubes.

This arch-shaped hydrogen gas brazing apparatus is more desirable when the refined hydrogen gas has the purity of 6N, and the heating time and the heating temperature of the heating unit are about 20 minutes at 1050° C. and 10 minutes at 1060° C., respectively, in case nickel-based or silver solder-based filler, G1650 or G1700 diamond are used.

The brazing method using the arch-shaped hydrogen gas brazing apparatus for brazing a diamond tool according to one embodiment of the present invention, wherein the brazing object is a metal bulk to which a plurality of diamond particles adhered directly, wherein the apparatus includes a heating unit including an outside wall, a second furnace core tube coupled horizontally from an inlet to an outlet, and a heating device for heating the brazing object moved from the inlet into the outlet, wherein the inlet and outlet are formed at both sides of the outside wall, and an adiabatic member is set to the insides of the outside wall; a supplying unit including a first furnace core tube to move the brazing object into the inlet, wherein the first furnace core tube is coupled to the inlet and is extended with downward tilt from the inlet; a cooling unit including a third furnace core tube and a cooling device for cooling the brazing object moved from the outlet through the third furnace core tube, wherein the third furnace core tube is coupled to the outlet and is extended with downward tilt from the outlet; a moving unit for moving the brazing object using a conveyer set to inside of the first, second and third furnace core tube; and a hydrogen gas supplying unit for supplying a hydrogen gas to the first, second and third furnace core tubes, the method comprises supplying the hydrogen gas to the first, second and third furnace core tube through the hydrogen gas supplying unit; discharging gas heavier than the hydrogen gas through the first and third furnace core tubes; moving the brazing object with a filler spread thereon into the heating unit through the supplying unit; heating the brazing object in the heating unit, thereby melting the filler; and moving the brazing object through the cooling unit to cool the melted filler. The method further includes refining the hydrogen gas through the hydrogen gas refinery. The refined hydrogen gas having the purity of 6N, a nickel-based or silver solder-based filler, and G1650 and G1700 diamonds are used. In addition, each of the heating time and the heating temperature of the heating unit are about 20 minutes at 1050° C., or 10 minutes at 1060° C.

As described above, because the furnace core tubes are filled with the hydrogen gas atmosphere, the hydrogen gas brazing method for manufacturing a diamond tool and the hydrogen gas brazing apparatus for performing the same according to one embodiment of the present invention prevent the diamond particle from oxidation and carbonization at high temperature. Particularly, the hydrogen gas brazing method for manufacturing the diamond tool and the hydrogen gas brazing apparatus for performing the same prevent the diamond particle from oxidation and carbonization by supplying the hydrogen gas of high degree of purity when brazing temperature rises.

### BRIEF DESCRIPTION OF THE DRAWINGS

The above and other features and advantages of the present invention will become readily apparent by reference to the following detailed description hen considered in conjunction with the accompanying drawings wherein:

FIG. 1 is a perspective view illustrating a conventional diamond tool;

FIG. 2 is a perspective view illustrating a diamond tool with diamond particles fixed to the metal bulk by brazing method after adhered directly to the metal bulk;

FIG. 3 is a side view illustrating an arch-shaped brazing apparatus according to one embodiment of the present invention; and

FIG. 4 is a cross-sectional view illustrating a heating unit taken along the line of IV-IV of FIG. 3.

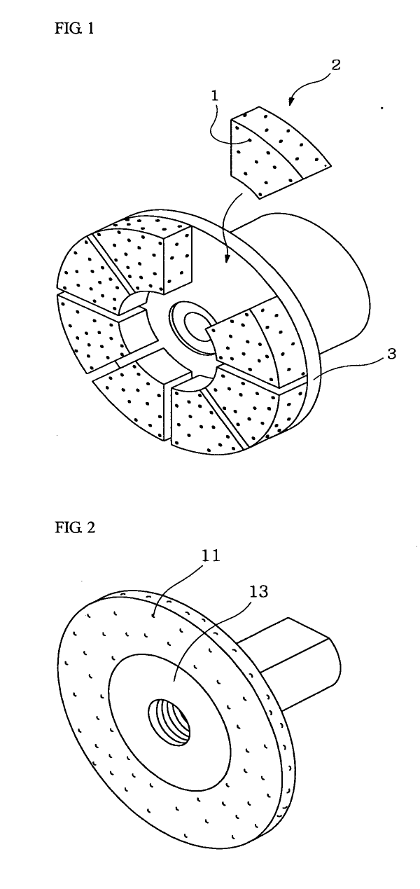

### DESCRIPTION OF EMBODIMENTS

Hereinafter, the preferred embodiments of the present invention will be explained in more detail with reference to the accompanying drawings.

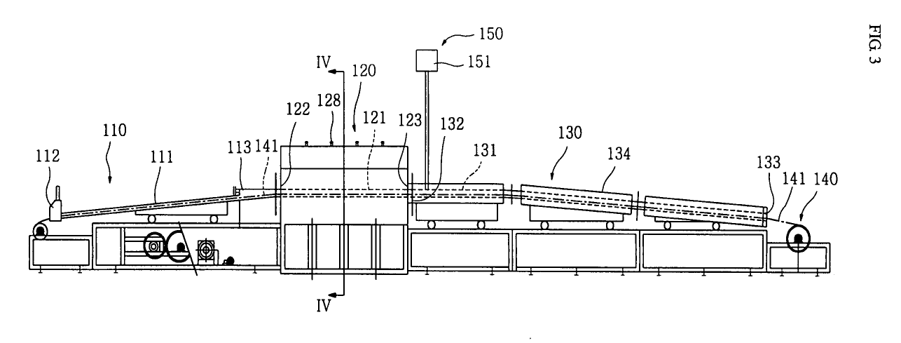

FIG. 3 is a side view illustrating an arch-shaped brazing apparatus according to one embodiment of the present invention.

Referring to FIG. 3, the brazing apparatus of the present invention includes a supplying unit 110, a heating unit 120, and a cooling unit 130 coupled in sequence, wherein the units 110, 120 and 130 have furnace core tubes 111, 121 and 131, respectively.

It is desirable that the brazing object is a metal bulk to which diamond particles are directly adhered. The brazing object is moved from the supplying unit 110 into the cooling unit 130 via the heating unit 120 by the moving unit 140. Particularly, the brazing object is moved through the furnace core tubes 111, 121, and 131.

In the present specification, for example, the toughness index (hereinafter, referred to as “T.I”) of a diamond having the level of G1300 (hereinafter, referred to as “G1300 diamond”) is 40 to 45, and the thermal toughness index (hereinafter, referred to as “T.T.I”) thereof is 30 to 38. In addition, the T.I of a diamond having the level of G1650 (hereinafter, referred to as “G1650 diamond”) is 66 to 70, and the T.T.I thereof is 55 to 60. Further, the T.I of a diamond having the level of G1700 (hereinafter, referred to as “G1700 diamond”) is 72 to 75, and the T.T.I thereof is 62 to 65. Here, “T.I” indicates the percentage of uncrushed part in a diamond after crushing a diamond of about 2 to 3 carats with a certain size of steel balls in a capsule at normal temperature. “T.T.I” represents the percentage shown by T.I after maintaining the diamond at a temperature of about 900 to 1100° C. under non-oxidation atmosphere for 15 minutes.

A hydrogen gas supplying unit 150 is coupled to the third furnace core tube 131 at an inlet 132 of the cooling unit 130. In addition, the hydrogen gas supplying unit 150 supplies hydrogen gas to the furnace core tubes 111, 121 and 131 so that the furnace core tubes 111, 121 and 131 are filled with the hydrogen gas, respectively.

The supplying unit 110 includes the first furnace core tube 111 extended with upward tilt toward an inlet 122 of the heating unit 120. The cooling unit 130 includes the third furnace core tube 131 extended with downward tilt from an outlet 123 of the heating unit 120. Therefore, the whole shape of the furnace core tubes 111, 121 and 131 coupled in sequence is arch.

The cooling unit 130 includes a cooling device for cooling rapidly the brazing object. For example, the cooling device is a plurality of water-cooled jackets 134 surrounding the third furnace core tube 131. The water-cooled jackets cool the brazing object. Because the cooling unit 130 includes the plural water-cooled jackets 134, the water-cooled jackets 134 are easily assembled and repaired, respectively.

The moving unit 140 is a kind of conveyer 141, and controls the moving velocity of the brazing object by using a motor. The conveyer 141 is set inside the furnace core tubes 111, 121 and 131, thereby moving the brazing object. It is desirable that the conveyer 141 is a mesh belt conveyer.

The hydrogen gas supplying unit 150 includes a hydrogen gas refinery 151 to refine hydrogen gas, and supplies the refined hydrogen gas to the furnace core tubes 111, 121 and 131. Particularly, the hydrogen gas refinery 151 separates the hydrogen gas from a hydrogen gas compound with using absorption method, and supplies the separated hydrogen gas having a high degree of purity to the furnace core tubes 111, 121 and 131.

The hydrogen gas supplied from the hydrogen gas supplying unit 150 is lighter than any other gas in the furnace core tubes 111, 121 and 131. Therefore, the hydrogen gas is filled from the upside of the furnace core tubes 111, 121 and 131 to the downside thereof. In addition, because the whole shape of the furnace core tubes 111, 121 and 131 is arch, the gases heavier than the hydrogen gas are pushed and moved into the supplying unit 110 and the cooling unit 130 by the hydrogen gas, and then is discharged through the inlet 112 of the supplying unit 110 and the outlet 133 of the cooling unit 130. As a result, the furnace core tubes 111, 121 and 131 have only the hydrogen gas. In other words, the furnace core tubes 111, 121 and 131 are filled with the hydrogen gas of a high degree of purity.

Hereinafter, the degree of purity of the hydrogen gas is expressed in a combination of number and N (nine). For example, 2N indicates that the hydrogen gas has a degree of purity of about 99.0 to 99.9%, and 3N represents that the hydrogen gas has a degree of purity of about 99.9 to 99.99%.

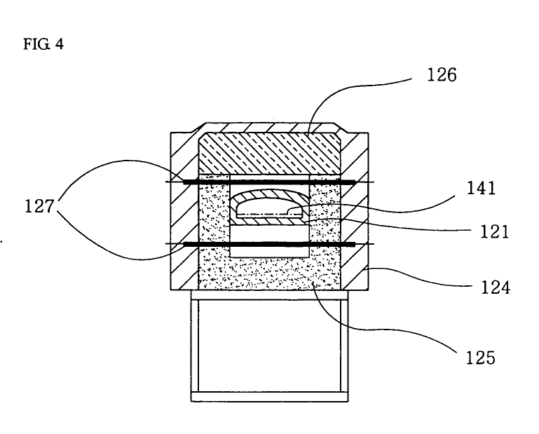

FIG. 4 is a cross-sectional view illustrating the heating unit taken along the line of IV-IV of FIG. 3.

Referring to FIG. 3 and FIG. 4, the heating unit 120 has the inlet 122 and an outlet 123 at both sides of an outside wall 124. The second furnace core tube 121 coupled from the inlet 122 to the outlet 123 is set horizontally in the heating unit 120.

The outside wall 124 includes a steel plate. An adiabatic member 125 is set to the insides of the outside wall 124 except the top side as shown in FIG. 4. Firebrick may be used as the adiabatic member. A ceramic fiber 126 is also filled in the top side. As a result, the heat transfer from the inside to the outside of the heating unit 120 is prevented, and so the heat efficiency of the heating unit 120 is enhanced.

A heating device 127 including nonmetallic heating element is set to the top and bottom of the second furnace core tube 121. The heating device 127 increases the inside temperature of the heating unit 120 in order to heat the brazing object placed in the second furnace core tube 121.

Heating time is adjusted by controlling the moving velocity of the conveyer 141. In addition, a plurality of temperature sensors are set on the top of the second furnace core tube 121 to measure the inside temperature of the heating unit 120. The measured temperature may be transmitted to a controller (not shown). The controller controls the heating device 127 in order to maintain the inside temperature of the heating unit 120.

Hereinafter, the method of manufacturing the diamond tool according to one embodiment of the present invention will be explained in more detail.

The hydrogen gas refined by the hydrogen gas refinery 150 is supplied to the second furnace core tube 121 through the hydrogen gas supplying unit 150. When the second furnace core tube 121 is filled with the hydrogen gas having a high degree of purity, the diamond particle is not oxidized nor carbonized even though the second furnace core tube 121 has high inside temperature.

The other gases except the hydrogen gas in the second furnace core tube 121 are pushed to the inlet 122 and the outlet 123 according as the inside of the second furnace core tube 121 is filled with the hydrogen gas. Subsequently, the other gases are pushed along the supplying unit 110 extended with downward tilt from the inlet 122 and the cooling unit 130 extended with downward tilt from the outlet 123, and then are discharged through the inlet 112 of the supplying unit 110 and the outlet 133 of the cooling unit 130. As a result, the furnace core tubes 111, 121 and 131 only have the hydrogen gas. In other words, the furnace core tubes 111, 121 and 131 are filled with the hydrogen gas of a high degree of purity.

Subsequently, the brazing object with the filler spread thereon is supplied through the inlet 112 of the supplying unit 110, and then is moved into the inlet 122 of the heating unit 120 through the conveyer 141.

The inside temperature of the heating unit 120 is augmented by the heat generated from the heating device 127. When the inside temperature is augmented enough to melt the filler, the melted filler is permeated between the metal bulk and the diamond particles.

The brazing object may be held in the heating unit 120 for a certain period of time by controlling the moving velocity of the conveyer 141. In addition, the heating temperature may be controlled by the controller coupled to the temperature sensor 128. The brazing object is moved from the inside of the heating unit 120 into the outlet 123 for a certain period of time at a certain temperature.

The brazing object is moved through the cooling unit 130. When the melted filler is cooled, the diamond particles are fixed to the metal bulk. The water-cooled jacket 134 surrounding the third furnace core tube 131 rapidly cools the brazing object.

The cooling unit 130 is filled with the hydrogen gas up to the outlet 133. Therefore, the oxidation and carbonization of the diamond particles do not occur until the filler is completely cooled.

On the other hand, the temperature and time required to melt the filler in the heating unit 120 were optimized through experiment. In the experiment for optimization, a nickel-based or silver solder-based filler, and G1650 and G1700 diamonds with less impurities were used. In addition, in the experiment for optimization, the hydrogen gas having a high degree of purity of 6N was supplied through the hydrogen gas refinery 151. Under this condition, the heating time was set to about 20 minutes when the heating temperature was about 1050° C., and about 10 minutes when the heating temperature about 1060° C.

Here, BNi-2 [chromium (Cr) 7%, boron (B) 3%, silicon (Si) 4.5%, carbon (C) 0.05%, iron (Fe) 3%, and nickel (Ni) 82.45% ] and BNi-7 [Cr 13%, phosphorous (P) 10%, and Ni 77% ] were the nickel-based filler, and BAg-8T [argentums (Ag) 70%, copper (Cu) 28% and titanium (Ti) 2% ] was employed as the silver solder-based filler in the experiment.

To obtain the optimized condition, the kind of diamond was determined through the experiment for carbonization of the brazed diamond particles. Additionally, the degree of purity of the hydrogen gas and the heating temperature were determined by examining the carbonization of the diamond particle through increasing the degree of the purity of the hydrogen gas.

Subsequently, the bonding strength between the diamond particle and metal bulk was measured after the heating time was changed in accordance with the selected heating temperature in the brazing process, and then the optimized heating time was determined corresponding to the measured bonding strength.

Table 1 shows the carbonization degree of the diamond particles after brazing G1300, G1650 and G1700 diamonds for 30 minutes at a heating temperature of about 1030 to 1100° C., wherein the degree of purity of the hydrogen gas was set to 5N.

Table 2 shows the carbonization degree of the diamond particles after brazing G1300, G1650 and G1700 diamonds for 30 minutes at a heating temperature of about 1030 to 1100° C., wherein the degree of purity of the hydrogen gas was set to 6N. Table 3 shows the bonding strength between the diamond particle and the metal bulk. Herein, ‘o’ indicates ‘very good,’ ‘Δ’ represents ‘ok,’ and ‘x’ means ‘bad.’

TABLE 1

| | G1300 | G1650 | G1700 |
|---|---|---|---|
| 1030° C. | Δ | ∘ | ∘ |
| 1040° C. | Δ | ∘ | ∘ |
| 1050° C. | Δ | Δ | ∘ |
| 1060° C. | x | Δ | ∘ |
| 1070° C. | x | Δ | x |
| 1080° C. | x | x | x |
| 1090° C. | x | x | x |
| 1100° C. | x | x | x |

TABLE 2

| | G1300 | G1650 | G1700 |
|---|---|---|---|
| 1030° C. | ∘ | ∘ | ∘ |
| 1040° C. | ∘ | ∘ | ∘ |
| 1050° C. | ∘ | ∘ | ∘ |
| 1060° C. | ∘ | ∘ | ∘ |
| 1070° C. | Δ | Δ | Δ |
| 1080° C. | Δ | Δ | Δ |
| 1090° C. | x | Δ | Δ |
| 1100° C. | x | x | Δ |

TABLE 3

| | G1300 | G1650 | G1700 |
|---|---|---|---|
| 1030° C. | x | x | x |
| 1040° C. | x | Δ | Δ |
| 1050° C. | Δ | ∘ | ∘ |
| 1060° C. | Δ | ∘ | ∘ |
| 1070° C. | x | Δ | ∘ |
| 1080° C. | x | Δ | Δ |
| 1090° C. | x | Δ | Δ |
| 1100° C. | x | Δ | Δ |

The above tables show that it is desirable to braze G1650 and G1700 diamonds at a heating temperature of about 1050 to 1060° C. and the degree of purity of the hydrogen gas of 6N.

Table 4 shows the bonding strength after brazing G1650 diamond as the heating time was changed at a heating temperature of about 1050 to 1060° C. at the degree of purity of the hydrogen gas of 6N.

Table 5 shows the bonding strength after brazing G1700 diamond as the heating time was changed at a heating temperature of about 1050 to 1060° C. at the degree of the hydrogen gas of 6N.

TABLE 4

| | 10 minutes | 20 minutes | 30 minutes |
|---|---|---|---|
| 1050° C. | Δ | ∘ | x |
| 1060° C. | ∘ | Δ | x |

TABLE 5

| | 10 minutes | 20 minutes | 30 minutes |
|---|---|---|---|
| 1050° C. | Δ | ∘ | Δ |
| 1060° C. | ∘ | Δ | x |

Tables 4 and 5 show that it is desirable the heating time for G1650 or G1700 diamond with the nickel-based filler or the silver solder-based filler is 20 minutes when the heating temperature is about 1050° C. and the degree of the purity of the hydrogen gas is 6N. In addition, the heating time for G1650 or G1700 diamond is 10 minutes when the heating temperature is about 1060° C.

From the preferred embodiments for the hydrogen gas brazing method for manufacturing a diamond tool and an arch-shaped hydrogen gas brazing apparatus for performing the same, it is noted that modifications and variations can be made by a person skilled in the art in light of the above teachings. Therefore, it should be understood that changes may be made for a particular embodiment of the present invention within the scope and the spirit of the present invention outlined by the appended claims.

1. An arch-shaped hydrogen gas brazing apparatus for brazing a brazing object, wherein the brazing object is a metal bulk to which a plurality of diamond particles adhered directly, comprising:
a heating unit having an outside wall, a second furnace core tube coupled horizontally from an inlet to an outlet, and a heating device for heating the brazing object moved from the inlet into the outlet, wherein the inlet and the outlet are formed at both sides of the outside wall, and an adiabatic member is set to the insides of the outside wall;
a supplying unit having a first furnace core tube to move the brazing object into the inlet, wherein the first furnace core tube is coupled to the inlet and is extended with downward tilt from the inlet;
a cooling unit having a third furnace core tube and a cooling device for cooling the brazing object moved from the outlet through the third furnace core tube, wherein the third furnace core tube is coupled to the outlet and is extended with downward tilt from the outlet;
a moving unit for moving the brazing object using a conveyer set to the inside of the first, second, and third furnace core tubes; and
a hydrogen gas supplying unit for supplying hydrogen gas to the first, second and third furnace core tubes.

2. The apparatus of claim 1, wherein the heating device corresponds to a nonmetallic heating element set to the top and bottom of the second furnace core tube.

3. The apparatus of claim 1, wherein a plurality of temperature sensors are set on the top of the second furnace core tube.

4. The apparatus of claim 1, wherein the cooling device includes a plurality of water-cooled jackets surrounding the third furnace core tube.

5. The apparatus of claim 1, wherein the conveyer includes a mesh belt.

6. The apparatus of claim 1, wherein the hydrogen gas supplying unit includes a hydrogen gas refinery to refine the hydrogen gas, and then supplies the refined hydrogen gas to the first, second and third furnace core tubes.

7. The apparatus of claim 6, wherein the refined hydrogen gas having the degree of purity of 6N, nickel-based or silver solder-based filler, and G1650 and G1700 diamonds are used, and each of the heating time and heating temperature of the heating unit is about 20 minutes and about 1050° C.

8. The apparatus of claim 6, wherein the refined hydrogen gas having the degree of purity of 6N, nickel-based or silver solder-based filler, and G1650 and G1700 diamonds are used, and each of the heating time and heating temperature of the heating unit is about 10 minutes and about 1060° C.

9. A hydrogen gas brazing method using an arch-shaped hydrogen gas brazing apparatus for brazing a brazing object, wherein the brazing object is a metal bulk to which a plurality of diamond particles adhered directly, wherein the apparatus includes:
a heating unit having an outside wall, a second furnace core tube coupled horizontally from an inlet to an outlet, and a heating device for heating the brazing object moved from the inlet into the outlet, wherein the inlet and the outlet are formed at both sides of the outside wall, and an adiabatic member is set to the insides of the outside wall;
a supplying unit having a first furnace core tube to move the brazing object into the inlet, wherein the first furnace core tube is coupled to the inlet and is extended with downward tilt from the inlet;
a cooling unit having a third furnace core tube and a cooling device for cooling the brazing object moved from the outlet through the third furnace core tube, wherein the third furnace core tube is coupled to the outlet and is extended with downward tilt from the outlet;
a moving unit for moving the brazing object using a conveyer set to the inside of the first, second, and third furnace core tubes; and
a hydrogen gas supplying unit for supplying hydrogen gas to the first, second and third furnace core tubes,
the method comprising:
supplying the hydrogen gas to the first, second and third furnace core tubes through the hydrogen gas supplying unit;
discharging gases heavier than the hydrogen gas through the first and third furnace core tubes;
moving the brazing object with a filler spread thereon into the heating unit through the supplying unit;
heating the brazing object in the heating unit, thereby melting the filler; and
moving the brazing object through the cooling unit to cool the melted filler.

10. The method of claim 9, further including refining the hydrogen gas through the hydrogen gas refinery.

11. The method of claim 10, wherein the refined hydrogen gas having the degree of purity of 6N, nickel-based or silver solder-based filler, G1650 and G1700 diamonds are used, and each of the heating time and heating temperature of the heating unit is about 20 minutes and about 1050° C.

12. The method of claim 10, wherein the refined hydrogen gas having the degree of purity of 6N, nickel-based or silver solder-based filler, G1650 and G1700 diamonds are used, and each of the heating time and heating temperature of the heating unit is about 10 minutes and about 1060° C.
